(19) United States
(12) Patent Application Publication
(10) Pub. No.: US 2013/0168420 A1
(43) Pub. Date: Jul. 4, 2013

(54) FUEL TRANSFER PUMP FOR PORTABLE STORAGE CONTAINERS

(71) Applicant: Eric Matthew Kern, Macomb, MI (US)

(72) Inventor: Eric Matthew Kern, Macomb, MI (US)

(21) Appl. No.: 13/604,615

(22) Filed: Sep. 5, 2012

Related U.S. Application Data
(60) Provisional application No. 61/573,443, filed on Sep. 6, 2011.

(51) Int. Cl. B67D 7/84

(52) U.S. Cl. CPC B67D 7/845
USPC 222/608; 222/401

(57) ABSTRACT

The present invention is a fuel transfer pump for use with standard portable containers of various sizes, shapes, manufacturers and configurations. The fuel transfer pump allows the user to fuel objects higher or lower than the portable container, quickly, without the need to lift the portable container. The core components of the invention are a wheeled framework (cart), clear flexible tubing, fill handle/nozzle (shut-off valve), double-action air pump with hose, and connector sleeve, which, generally speaking, are configured as follows: the connector sleeve attaches and seals the portable container outlet to the tubing, which extends down to the bottom of the container on one end and has the fill handle/nozzle (shut-off valve) at the other end; the sleeve also has a port to attach and seal to the air pump hose to enable pressurizing the container, inducing fuel flow.

### CROSS-REFERENCE TO RELATED APPLICATIONS

This application is a continuation of Provisional Patent Application No. 61/573,443 filed on Sep. 6, 2011.

### BACKGROUND OF THE INVENTION

1. Field of the Invention

The present invention relates generally to fuel transfer pumps for portable storage containers.

2. Background, Description of Prior Art

Currently there are a number of solutions for transferring fuel from portable containers to fill objects with fuel. Some of these solutions attempt to improve the situation, but these solutions fail to meet the needs of the industry because they do not address the requirement to have the portable container higher than the objects being fueled; they rely on siphon (atmospheric pressure) for developing and maintaining flow. This also results in slow flow rates that take too long to dispense the fuel, and therefore do not satisfy the end user. This is the type of fluid transfer apparatus disclosed by Chisholm et al in U.S. Pat. No. 7,422,039. Other solutions seek to provide a pump to improve flow rate, but these solutions also fail to meet industry needs because they utilize rotary or positive displacement pumps that are expensive and are part of a commercial-style fuel dispensing container, not suited for residential use, such as disclosed by Varini in U.S. Patent 2011/0079303. Still other solutions seek to provide a pump to improve flow rate, but these solutions also fail to meet industry needs in so far as requiring a special container construction (when consumers already own standard containers) to house the pump as disclosed by Goguen in U.S. Pat. No. 4,972,972; or by still requiring lifting to move the container and not providing storage for the pump, handle and tubing as disclosed by Alex et al in U.S. Pat. No. 7,814,941. These latter two solutions also utilize inefficient single-action air pumps, not taking advantage of the return motion as would a double-action pump.

It would be desirable to have the ability to transfer fuel quickly and easily without having to lift heavy portable containers, which is not only difficult for some people but also leads to fuel spillage due to lack of control with both lifting and fueling. Furthermore, it would also be desirable to have a device that would utilize the user's existing portable fuel containers, so they become more easily used and not rendered obsolete by the new device. Still further, it would be desirable to have a fuel transfer pump that does not rely on the typically available siphon action (gravity) which requires the portable container to be higher than the object being filled, and also results in slow flow rates. While currently there exist commercial-style fuel containers with integral fuel pumps, these are expensive and do not address the needs of the typical homeowner who struggles with their existing 5 gallon (or larger) containers. Therefore, there currently exists a need in the industry for an inexpensive fuel transfer pump for residential use with existing containers.

### SUMMARY OF THE INVENTION

The present invention advantageously fills the aforementioned deficiencies by providing an inexpensive fuel transfer pump for portable storage containers, which provides a means for transferring fuel from the portable container quickly and easily without requiring lifting of the heavy, full container.

The present invention is a fuel transfer pump for use with an existing (standard) portable container, which is made up of the following components: (1) flexible tubing through which the fuel flows, the first end located at the bottom of the existing portable container, the other end extending through the outlet of the container, (2) a fill handle/nozzle (shut-off valve) located at the second end of the tubing, which is used to insert into the object being fueled, (3) a connector sleeve which secures and seals against both the outlet of the portable container and the tubing, using hose clamps at each end of the sleeve, (4) a double-action air pump with flexible hose and barbed end fitting which inserts and seals into a port in the connector sleeve, allowing for air to be pumped into the top portion of the container, above the fuel fluid level. The above components combine to form a sealed system which can then be pressurized by the air pump to provide positive pressure in the container, causing the fuel to flow through the tubing, with the flow being controlled using the fill handle/nozzle (shut-off valve) near the object being fueled. Also included in the present invention is (5) a wheeled framework (cart) to aid in moving the container as well as providing a structure for mounting the air pump and storing the flexible tubing and fill handle/nozzle (shut-off valve).

The present invention may also have one or more of the following: (6) hose clamps on the connector sleeve with features to allow for finger tightening (no tools required) so the device can be removed and installed on various containers quickly and easily without regard to thread pitch, (7) the main tubing with sufficient length so that the hose clamp at the connector sleeve can position the tube at various locations to ensure it is at the bottom of the specific container, (8) a notch feature in the end of the tubing at the end located at the bottom of the container so that the tube cannot accidently seal against the bottom of the container, limiting flow, (9) tubing can be transparent (preferred for visibility) or opaque, with the main feature being flexible but not easily kinked or collapsed, and long enough (about 8 feet) to reach objects to fuel, (10) the double-action air pump is low pressure/high volume design so as not to exceed the pressure limits of the portable container (which by its own design comprehends the maximum operating vapor pressure of a closed container).

The present invention is unique when compared with other known devices and solutions because the present invention provides: (1) positive pressure to provide fast fuel flow rates at a low cost, appropriate for residential use; and (2) no required lifting of the portable container to move it, or to develop and maintain flow as do siphon devices; and (3) the capability to be used with existing portable fuel containers without regard to the outlet thread pitch; and (4) the capability to be used with existing portable fuel containers without regard to the size and/or shape by various manufacturers; and (5) the capability to be used with both the older, vented containers and the newer (GARB compliant) non-vented containers.

The present invention is unique in that it is structurally different from other known devices or solutions. More specifically, the present invention is unique due to the presence of: (1) an double-action air pump to provide pressure for fast fuel flow rates at a low cost; and (2) a connector sleeve with finger operated hose clamps at each end of the sleeve, which seals on all container outlets regardless of the thread pitch (for screw-on fittings); and (3) the barbed end fitting on the air pump hose for positive, secure connection to the sleeve port; and (4) for existing portable containers, a wheeled framework (cart) to both hold and aid in moving the container, as well as for providing a structure to mount the air pump and store the flexible tubing and fill handle/nozzle (shut-off valve); and (5) a notch feature in the end of the tubing at the end located at the bottom of the container so that the tube cannot accidently seal against the bottom of the container, limiting flow.

Among other things, it is an object of the present invention to provide a fuel transfer pump for portable storage containers that does not suffer from any of the problems or deficiencies associated with prior solutions.

It is still further an object of the present invention to create a device that is more economical to produce, easier to manufacture, easier to use, and more reliable.

Further still, it is an object of the present invention to create a device that is smaller and more lightweight than other solutions, thereby enabling the device to be more easily portable.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the present invention in its most complete version: wheeled framework (cart) 1; specific portable container 2; double-action air pump 3; clear flexible tubing 4 as stored on cart; fill handle 5/nozzle 14 (shut-off valve 13) as stored on cart.

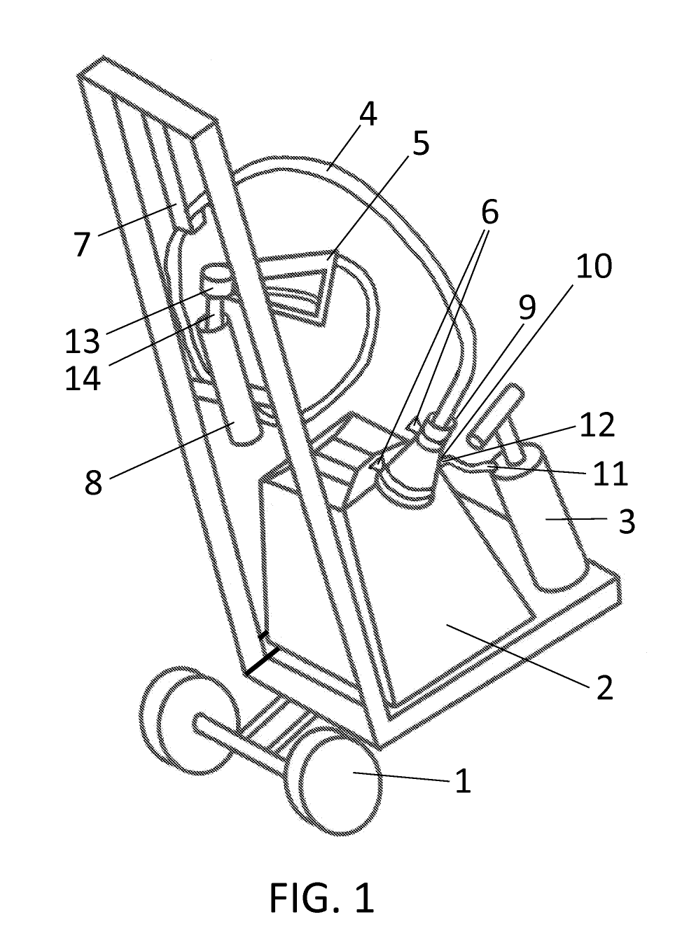

FIG. 2 shows the standard portable container 2, with the connector sleeve 9, locating the clear flexible tubing 4 with notch feature at the bottom end, secured in place with finger operated hose clamps 6 at each end of the sleeve.

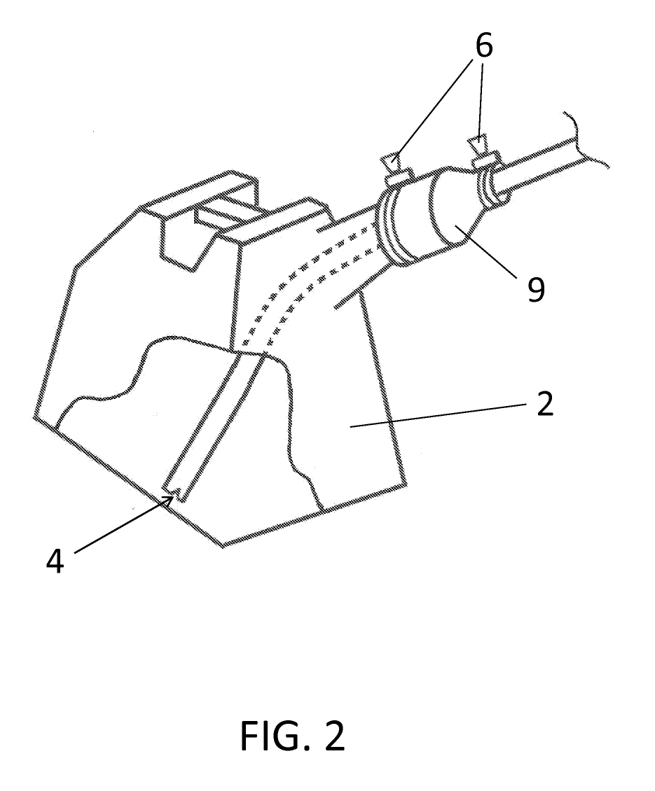

FIG. 3 shows the connector sleeve 9, with finger operated hose clamps 6 and the port 10 for air pump hose connector.

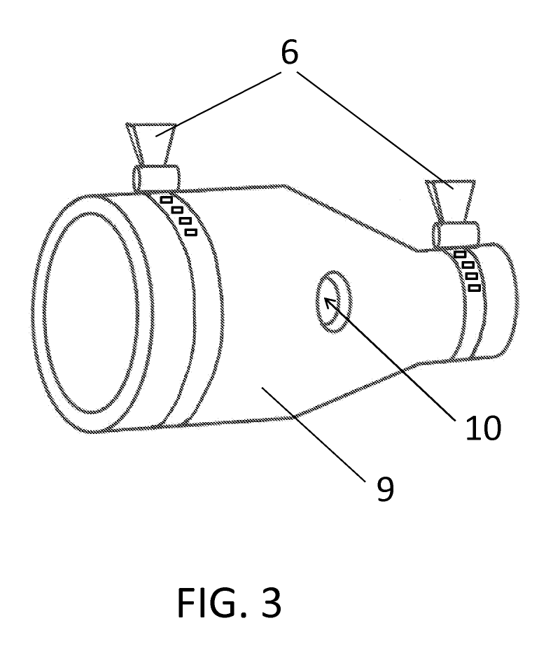

FIG. 4 shows the double-action cylinder air pump 3, with flexible hose 11 and barbed end fitting 12.

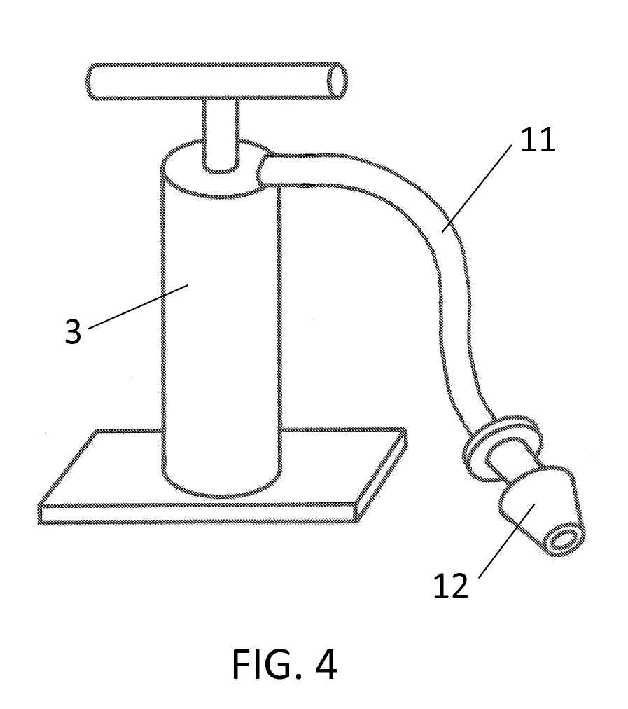

FIG. 5 shows the fill handle 5/nozzle 14 (shut-off valve 13) and the clear flexible tubing 4.

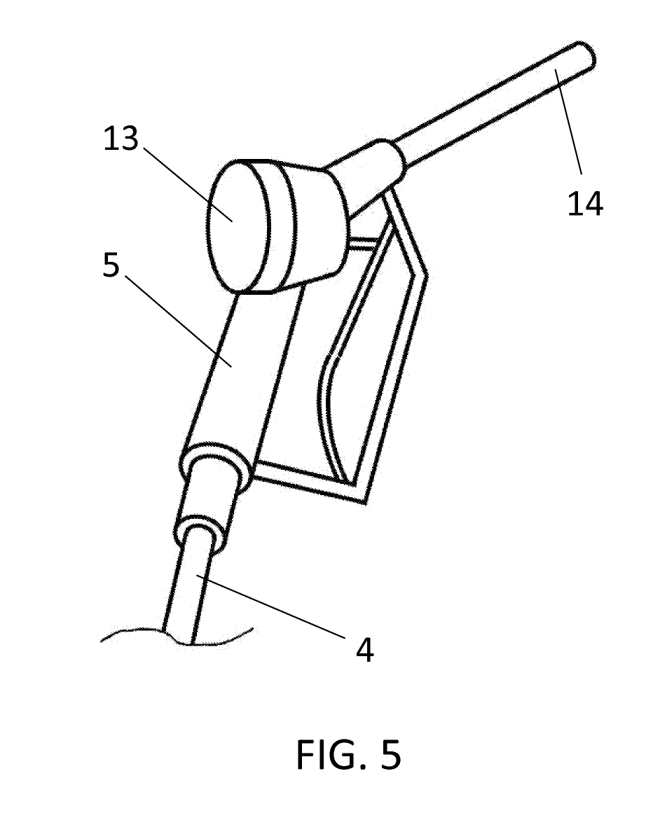

### DETAILED DESCRIPTION OF THE INVENTION

The present invention is directed to fuel transfer pumps for portable storage containers.

In its most complete version, the present invention is made up of the following components: clear flexible tubing 4, a fill handle 5/nozzle 14 (shut-off valve 13), a connector sleeve 9 with finger operated hose clamps 6 at each end of the sleeve, a double-action air pump 3 with an attached flexible hose and barbed end fitting, standard portable container 2, a wheeled framework (cart) 1 to both hold and aid in moving the container, as well as for providing a structure to mount the air pump and store the clear flexible tubing. These components are connected as follows to form a sealed system which can then be pressurized by the air pump to provide positive pressure in the container, causing the fuel to flow through the tubing, with the flow being controlled near the object being fueled by using the fill handle/nozzle (shut-off valve): The connector sleeve 9 has two specific end diameters, and is installed with the larger end onto the outlet of the standard portable container 2, and sealed by tightening the finger operated hose clamp 6. Then the clear flexible tubing 4 (end with notch) is inserted through the smaller diameter of the connector sleeve 9 until it reaches the bottom of the container 2, and then the second finger operated hose clamp 6 is tightened to locate and seal the tubing to the sleeve. The preferred tubing is clear to provide visibility of flow and its diameter is maximized to provide the least restriction and therefore greatest flow rate. The fill handle/nozzle (shut-off valve) is sized to be the same as the tubing size to minimize its restriction while in the open position, and yet small enough to fit into the typical vehicle gasoline fill opening. This would typically be tubing about ⅞ inch outer diameter and about ⅝ inch inner diameter. The double-action cylinder air pump 3 with its attached, flexible outlet hose and barbed end fitting, inserts and seals into a side port 10 in the connector sleeve 9, allowing for air to be pumped into the top portion of the container 2, above the fuel fluid level. The air pump is low pressure/high volume design so as not to exceed the pressure limits of the standard portable container (which by its own design must comprehend the maximum operating vapor pressure of a closed container). The double-action cylinder air pump produces air movement when both pushing and pulling the handle, thereby maximizing air flow for the user's movement and effort. The air pump is secured to a wheeled framework (cart) 1 onto which the standard portable container sits, for ease in moving to the object being fueled. The wheeled framework (cart) also has provision to store the length of flexible tubing and the fill handle/nozzle (shut-off valve) to keep it clean and prevent contact with the ground. It should further be noted that all of the various materials used for the above components are to be compatible with gasoline, and/or ethanol, and/or diesel fuels.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and claims. It is indeed intended that the scope of the invention should be determined by proper interpretation of the claims and their legal equivalents, as understood by those of skill in the art relying upon the disclosure in this specification and the attached drawings.

I claim:

1. A liquid transfer system comprising:
a wheeled framework (cart) to allow for moving the liquid transfer system without lifting.
a platform on said wheeled framework (cart) to locate a standard liquid container for easy installation and removal.
an air pump with hose, permanently mounted to said wheeled framework (cart) to enable the pressurization of said liquid container.
a fill handle/nozzle (shut-off valve) to control liquid flow from said liquid container.

2. The liquid transfer system of claim 1 further comprising clear, flexible tubing connecting said liquid container to said fill handle/nozzle (shut-off valve). The first end of said tubing having a notch feature to prevent unintended sealing to the bottom of said liquid container; the second end being attached to said fill handle/nozzle (shut-off valve).

3. The liquid transfer system of claim 2 further comprising a connector sleeve, with finger-tightened clamps, which seals said clear, flexible tubing to said liquid container, and has a port for installation of said air pump hose.

4. The liquid transfer system of claim 3 further comprising a storage feature on said wheeled framework (cart) to hold said fill handle/nozzle (shut-off valve).

5. The liquid transfer system of claim 4 further comprising a storage feature on said wheeled framework (cart) to hold said clear, flexible tubing.
